(19) United States
(12) Patent Application Publication
(10) Pub. No.: US 2007/0251398 A1
(43) Pub. Date: Nov. 1, 2007

(54) Chafer supports

(75) Inventors: John A. Wojcik, Sheboygan, WI (US); David M. Wasserman, Whitefish Bay, WI (US)

Correspondence Address: FOLEY & LARDNER LLP, 777 EAST WISCONSIN AVENUE, MILWAUKEE, WI, 53202-5306, US

(73) Assignee: The Vollrath Company, L.L.C.

(21) Appl. No.: 11/411,567

(22) Filed: Apr. 26, 2006

(51) Int. Cl. A47J 37/07

(52) U.S. Cl. 99/449

(57) ABSTRACT

A support for a chafer is disclosed. The support comprises an upper portion configured to be mounted to a chafer frame, a body portion, and a lower portion. The body portion is coupled to the upper portion and the lower portion, and is disposed therebetween.

### BACKGROUND

Chafer systems generally include a removable water pan that holds water and receives a food pan. These systems may include racks for holding the pans and supports for supporting the rack and pans above a source of heat and/or supporting surfaces such as counters or tabletops.

It is known to provide chafer supports comprising wires or metal bands. Such chafer supports are generally formed of a single, metal material, do not have a substantial cross section, are limited in strength, and are limited in their ability to be customized. Accordingly it would be advantageous to provide a chafer support having a more substantial cross section (e.g., a robust three dimensional structure) to increase strength. It would also be advantageous to provide a chafer support capable using multiple materials, including metallic and non-metallic materials. It would be further advantageous to provide a chafer support that is capable of being customized to provide a desired aesthetic quality.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY

The present invention relates to a a support for a chafer having a frame. The support comprises an upper portion configured to be coupled to the frame; a non-metallic body portion coupled to the upper portion and configured to provide structural support to the chafer; and a lower portion coupled to the body portion. At least one of the upper portion and the lower portion comprise a metallic material.

The present invention also relates to a chafer system comprising a receptacle; a frame supporting the receptacle; and a plurality of supports coupled to the frame. At least one of the supports comprises a mounting portion coupled to the frame, a foot portion, and a body portion extending between the mounting portion and the foot portion.

The present invention further relates to a chafer support configured to support a chafer rack. The support comprises a body portion configured to be coupled to a chafer rack. At least a portion of the body portion is translucent or transparent.

The present invention further relates to a chafer system comprising a frame configured to support a receptacle; and a plurality of supports coupled to the frame and configured to extend substantially vertically from the frame to a support surface. At least one of the supports comprises a body portion that is generally symmetrical about a longitudinal axis of the at least one support.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

FIG. 1 is a side elevation view of a chafer system according to an exemplary embodiment.

FIG. 2 is a fragmentary side elevation view of another embodiment of the chafer system of FIG. 1 according to an exemplary embodiment.

FIG. 3 is a side elevation view of a support of the system of FIG. 2.

FIG. 4 is a fragmentary perspective view of the support of FIG. 3.

FIG. 5 is a fragmentary perspective view of the support of FIG. 3.

FIG. 6 is a fragmentary perspective view of the support of FIG. 3.

FIG. 7 is a fragmentary side elevation view of another embodiment of the system of FIG. 1.

FIG. 8 is a cross-sectional view of a support of the system of FIG. 7 taken along line 8-8.

### DETAILED DESCRIPTION

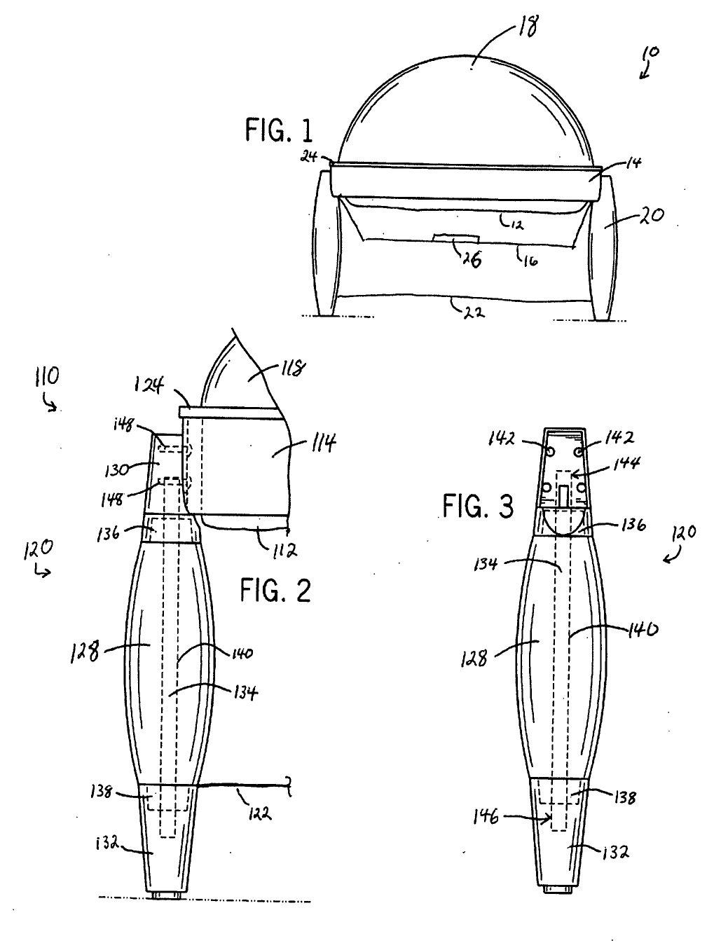

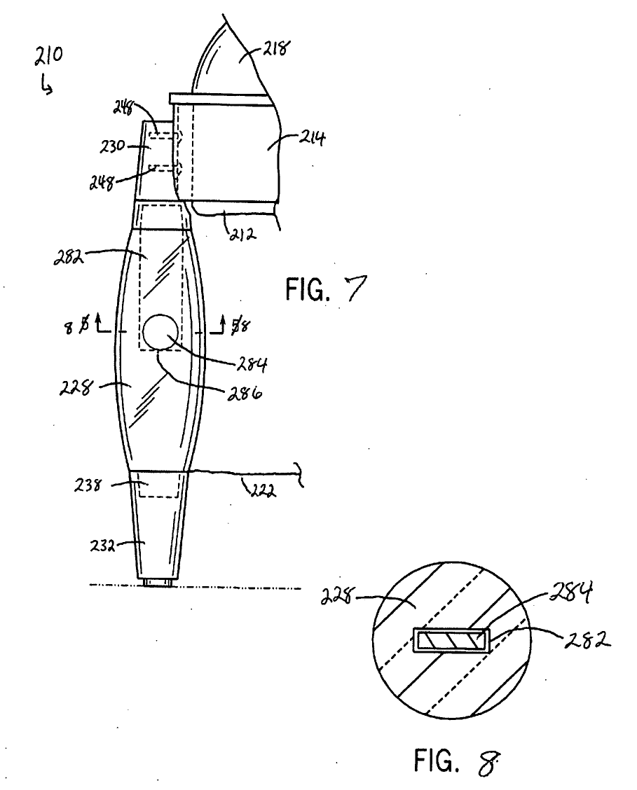

FIG. 1, as described further below, illustrates a chafer system 10 according to an exemplary embodiment that comprises supports 20 that have a substantial cross-section (e.g., thick, robust, etc. relative to the length of support 20 and/or support cross-members 22 and/or known wire or band supports) such that they may be orientated vertical and support the weight of chafer system 10 and its contents. FIGS. 2-6, as described further below, illustrate a chafer system 110 according to another exemplary embodiment that comprises chafer supports 120 that have a substantial cross-section and a metallic mounting portion in combination with a non-metallic body portion. The use of non-metallic materials is intended to thermally insulate chafer components of chafer system 120 from a supporting surface and provide a desirable aesthetic appearance. FIGS. 7 and 8, as described further below, illustrate a chafer system 210 according to yet another exemplary embodiment that comprises chafer supports 220 that have a substantial cross-section, a metallic mounting portion in combination with a non-metallic body portion wherein the non-metallic body portion is made from a transparent or translucent material. Such supports 220 may be used to incorporate a variety of aesthetic components including embedded indicia and/or other decorative elements.

FIG. 1 illustrates a chafer system 10 including a receptacle 12, a frame 14, a heat source support 16, a cover 18, supports 20 (e.g. members, legs, etc.), and support cross-members 22. Supports 20 have a substantial (e.g., thick, robust, etc. relative to the length of support 20 and/or support cross-members 22 and/or known wire or band supports) cross-section such that they may be orientated vertical and support the weight of chafer system 10 (and its contents). Receptacle 12 is shown as a water pan having a lip 24. Receptacle 12 may receive one or more nested food pans for holding and dispensing food. Frame 14 supports receptacle 12 above a surface such as a tabletop. Frame 14 is shown as a metal band that extends about receptacle 12 and contacts an underside of lip 24 to support receptacle 12. Heat source support 16 extends from one side of frame 14 to an opposing side and includes a heat source holder 26 which is configured to receive a cylindrical fuel holder for heating the food stored in chafer system 10. In some embodiments, heat source holder 26 may support a heat source in a position below receptacle 112 and be coupled to support 20.

Cover 18 is removably placed over receptacle 12 to insulate the contents of receptacle 12 to maintain temperature and/or moisture levels as well as to protect the contents of receptacle 12. In the embodiment shown, supports 20 are reinforced by support members 22 which extend between supports 20, for example, in a chafer system including four supports 20, two support members 22 my be used to connect opposing supports such that the two supports 22 cross over one another under frame 14.

Supports 20 support the rest of system 10 at a height above a surface to facilitate the dispensing of food, and to allow for the positioning of a heat source below receptacle 12. Supports 20 comprise an elongated structure coupled to frame 14 and extencing to a support surface. In one embodiment, supports 20 are coupled to frame 14 by fasteners, welding, or other suitable method for coupling. Each of supports 20 generally has a three-dimensional shape or configuration (as opposed to wire or metal bands). In the example shown, supports 20 are generally ovular in shape having a circular cross-section. Alternatively, supports 20 may have other geometries such as a generally rectangular shape with a rectangular, square, triangular, circular, oval, or polygonal cross-section. Any other suitable geometry may also be used. Supports incorporating a three-dimensional design allow for the use of different materials, provide greater strength, and allow for the incorporation of a variety of aesthetic designs.

For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

FIGS. 2 through 6 illustrate chafer system 110, another embodiment of chafer system 10 (shown in FIG. 1). Chafer system 110 is similar to system 10 except that system 110 includes supports 120 in lieu of supports 20. The remaining elements of system 110 which correspond to similar components of system to are numbered similarly. Chafer supports 120 have a substantial cross section and also employ a metallic mounting portion in combination with a non-metallic exterior (body portion). The use of non metallic materials is intended to thermally insulate chafer components of chafer system 120 from a supporting surface.

Each of supports 120 includes a body portion 128, an upper portions 130, a lower portion 132, and a coupling member 134. Body portion 128 of support 120 is configured to provide structural support to the chafer system and includes extensions 136 and 138, and bore 140. Extensions 136 and 138 extend into upper portion 130 and lower portion 132, respectively to facilitate coupling body portion 128 to upper portion 130 and lower portion 132.

Body portion 128 may be made of any suitable material including plastic or other polymeric material, wood, ceramic, or other non-metallic materials capable of providing structural support to the chafer system. Body portion 128 may include a variety of surface finishes according to the aesthetic desire of a customer. For example, body portion 128 may be at least partially made of wood having a stained, painted, or lacquered finish. In an exemplary embodiment, body portion 128 is constructed of wood. Wood is easily painted or otherwise finished to provide a desired aesthetic appearance. Also, the use of wood or other thermally insulating material insulates lower portion 132 from upper portion 130 to limit the transfer of heat from chafer system 110 to a support surface.

Upper portion 130 is configured to couple support 120 to frame 114. In the embodiment shown, upper portion 130 is made of metal. The use of a metal component for upper portion 130 allows for a variety of coupling techniques, including welding and/or fastening, to be used in connecting support 120 to frame 114 while using other materials, including wood or plastic for body portion 128. Lower portion 132 may be selected to match upper portion 130 in appearance to provide a desireable aesthetic effect.

In some embodiments upper portion 130 may be configured to threadably engage extension 136 of body portion 128. In yet other embodiments, upper portion 130 may be coupled to body portion 128 by fasteners, welding, adhesives, or other means for coupling the components. Similarly, any of the alternatives are equally applicable to coupling lower portion 132 to body portion 128.

Upper portion 130 is coupled to frame 114 by fasteners 148 which pass through a portion of frame 114 and are received in apertures 136 of upper portions 130. Fasteners 148 may be screws that are configured to threadably engage apertures 136. Alternatively, fasteners 148 may be rivets, bolts, or other suitable fasteners. In some embodiments, support 120 may be coupled to frame 114 by welding or other suitable means.

In the embodiment shown, support cross-member 22 are configured to provide lateral support and extends between two of supports 120 of chafer system 110. Support member 22 is coupled at a point between body portion 128 and lower portion 132. Alternatively, support member 122 may be coupled to support 120 at a point between body portion 128 and upper portion 130.

FIGS. 2 and 3 show coupling member 134 which couples body portion 128, upper portions 130, and lower portion 132. In the shown embodiment, coupling member 134 is a threaded rod configured to threadably engage bore 144 in upper portion 130 and bore 146 in lower portion 132 and to extend through bore 140 in body portion 128. Such a configuration avoids the need for extensive machining of body portion 128 as bore 140 need not have a uniform diameter or be threaded. According to other embodiments, coupling member 134 may be configured to threadably engage upper portion 130 and lower portions 132 and not body portion 128 such that body portion 128 is “captured” between upper portion 130 and lower portions 132 (e.g., held in compression or the like). Coupling member 134 may be made of any of a variety of metallic and non-metallic materials.

In alternative embodiments, two coupling members may be used whereby one coupling member threadably engages an upper portion and a portion of a body portion proximate to the upper portion and a second coupling member threadably engages a lower portion and a portion of the body member proximate to the lower portion. In such embodiments, the two coupling member may extend into a single bore, such as bore 140, which extends the length of the body portion. In other embodiments, the two coupling members may each extend into partial bores extending into the body portion.

FIG. 4 shows a portion of support 120 of chafer system 110 (shown in FIGS. 2 and 3). Upper portion 130 is coupled to body portion 128 and includes an upper surface 150, a surface 152 and a cavity 154 defined by a lip 156 and surface 158. Upper portion 130 also includes apertures 136, surface 160, projection 162, and surface 164.

Upper surface 150 is shown as a generally flat surface that is substantially perpendicular to a longitudinal axis of chafer support 120. In other embodiments, upper surface 150 may be a curved surface or other desirable appearance that may compliment other components of chafer system 110.

According to the embodiment shown, cavity 154 is defined on some sides by lip 156, which extends along three sides, where one of the sides is proximate upper surface 150. When support 120 is coupled to frame 114 (see FIG. 2), lip 156 may contact an outwardly facing surface of frame 114. By providing cavity 154, the area of contact between upper portion 130 and frame 114 is reduced, which lessens heat transfer between frame 114 and support 120. The reduced contact area and also allows for relaxed machining tolerances in the construction of upper portion 130 as irregularities in surface 160 are less likely to interfere with the connection between upper portion 130 and frame 114.

In the embodiment shown, surface 160 is disposed within cavity 154 and is recessed within upper portion 130. In other embodiments, upper portion 130 may lack cavity 154 such that surface 160 is not recessed within upper portion 130. Apertures 136 extend into upper portion 130 from surface 160. Apertures 136 may be tapped such that fasteners 148 (shown in FIG. 2) may threadably engage apertures 136. Alternatively, apertures 136 may be configured to accommodate rivets or other types of fasteners for coupling chafer support 120 to frame 114. In yet other embodiments, support 120 may be coupled to frame 114 by welding or other method of connection. Alternatively, support 120 may be connected to a chafer system component other than frame 114.

Upper portion 130 includes a projection 162 which may be configured to mate with a corresponding opening (i.e. a groove, passage, channel detent, or other suitable structure) in frame 114. Alternatively, frame 114 may include a projection that is configured to mate with an opening in upper portions 130. Projection 162 may aid in aligning apertures 136 with corresponding openings in frame 114 when assembling chafer system 110. Projection 162 is shown as having a generally rectangular configuration; however, other configurations may be used.

Surface 164 may be generally flat or have a curved profile. Surface 164 in upper portion 130 provides open space to accommodate the bottom of receptacle 112 which extends below frame 114. Surface 164 may be formed by molding processes, milling, or other methods for producing a desired shape when initially forming upper portion 130 or by removing material therefrom.

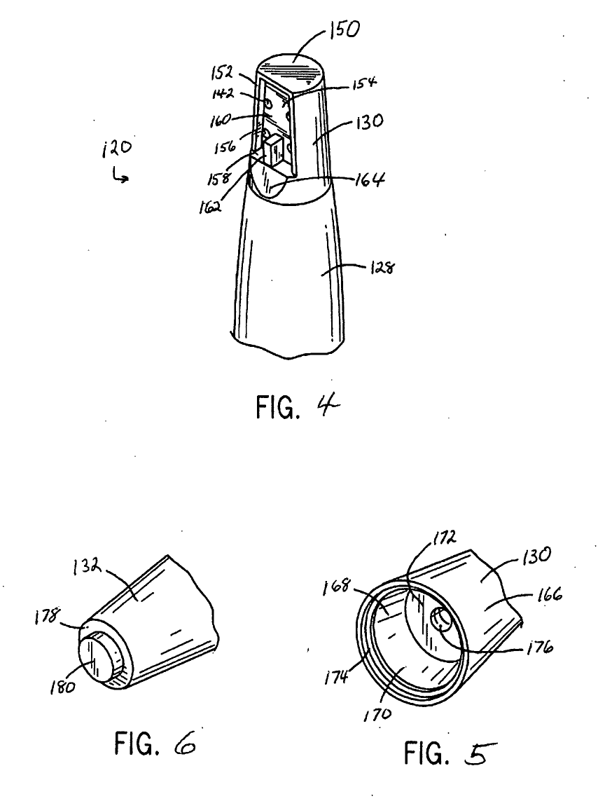

FIG. 5 upper portion 130 which includes an outer surface 166, a cavity 168, a surface 170, surface 172, threaded region 174, and aperture 176. Cavity 168 may be defined by surface 170 and surface 172. Cavity 168 may be configured to accommodate an extension (e.g. extension 136 or 138 of body portion 128 in FIG. 2) to facilitate coupling upper portion 130 to body portion 128 (shown in FIG. 2). In some embodiments, surface 170 may include a threaded region 174 that is configured to threadably couple upper portion 130 to the extension received in cavity 168. Aperture 176 may extend into upper portion 130 from surface 172. Aperture 176 is configured to receive a portion of a coupling member (e.g. coupling member 134 in FIG. 2). Aperture 176 may be tapped such that upper portion 130 may be threadably coupled to a coupling member. The configuration of upper portion 130 shown in FIG. 6 is equally applicable to lower portion 132.

FIG. 6 shows a portion of lower portion 132. Lower portion 132 may include a surface 178 and a projection 180. In some embodiments, projection 180 may be a non-skid pad such as a felt pad. In other embodiments, projection 180 may include an elastomeric material. Projection 180 may be coupled to surface 166 by adhesive, fastener, or other suitable method for attachment. Projection 180 may be threadably coupled to lower portion 132 such that rotational movement of projection 180 changes the relative positions of lower portion 132 and projection 180 along a longitudinal axis of support 120. Such a configuration allows a user to adjust and level chafer system 110 should the surface on which chafer system 110 is resting is not level. In some embodiments, projection 180 may be seated within a recess in surface 166.

Lower portion 132 contacts a surface, such as a tabletop, when chafer system 110 is in use. Projection 180 is generally configured to provide a frictional contact with the surface to prevent sliding or other movement of chafer system 110 in relation to the surface.

In some embodiments, upper portion 130 and lower portion 132 may comprise the same material. In other embodiments, upper portion 130 and lower portion 132 may comprise different materials. Upper portion 130 and lower portion 132 may be made of metal, plastic, wood, or any other suitable material. In some embodiments, upper portion 130 and lower portion 132 may be made of a metal such as polished aluminum or stainless steel, or metallic appearing material plastic so that upper portion 130 and lower portion 132 have a similar appearance to one or more components of chafer system 110.

Upper portion 130 and/or lower portion 132 may be formed as a single unitary body. Alternatively, upper portion 130 may be formed from a plurality of components coupled together to form upper portions 130.

FIGS. 7 and 8 illustrate chafer system 210, another embodiment of chafer system 10 (shown in FIG. 1). Chafer system 210 is similar to system 110 except that system 210 includes supports 220 in lieu of supports 120. The remaining elements of system 210 which correspond to similar components of system to are numbered similarly. Chafer supports 220 have a substantial cross-section, a metallic mounting portion in combination with a non-metallic body portion comprising a transparent or translucent material. Supports 220 may be used to incorporate a variety of aesthetic components including embedded (e.g., integrally molded, encased, inserted, etc.) indicia and/or other decorative elements (e.g., three-dimensional articles, logos, symbols, objects, products, lighting elements, labels, etc.).

Support 220 includes a body portion 228, an upper portion 230, and a lower portion 232. Body portion 228 of support 220 is configured to provide structural support to the chafer system and comprises extensions 236 and 238, and bore 282. Extensions 236 and 238 extend into upper portion 230 and lower portion 232, respectively.

Body portion 228 comprises a clear material such acrylic, polycarbonate, polypropylene, polyethylenes, acrylonitrile butadiene styrene (“ABS”), polyurethane, or other polymer with transparent or translucent properties, glass, or the like. Bore 282 extends from extension 236 into body portion 228. Decorative article 284 may be placed in bore 282 such that decorative article 284 rests on bottom 286 of bore 282. Decorative article 284 is shown as a round, three-dimensional article such as a medallion, figurine, colored piece, letter or the like. Alternatively, decorative article 284 may be a cube, sphere or other suitable shape. A design such as a logo, trademark or other design may be emblazoned, etched, printed, or otherwise placed on the surface of decorative article 284. Decorative article 284 and/or bore 282 may be configured such that decorative article 284 is held in a fixed position relative to body portion 228. Body portion 228 is removably coupled to upper portion 230 such that bore 282 may be exposed to remove and replace decorative article 284.

In other embodiments, body portion 228 may be adorned with one or more decorative articles disposed on an outer surface of the body portion, or within a recess in the body portion. The decorative article may be embedded within the body portion, for example, by overmolding the decorative article to form the body portion.

Chafer systems 10, 110, and 210 provide “substantial” three-dimensional supports 20, 120, and 220 for elevating and supporting the rest of the chafer system above a surface.

Although the foregoing has been described with reference to example embodiments, workers skilled in the art will recognize that changes may be made in form and detail without departing from the spirit and scope thereof. For example, although different example embodiments may have been described as including one or more features providing one or more benefits, it is contemplated that the described features may be interchanged with one another or alternatively be combined with one another in the described example embodiments or in other alternative embodiments. Because the technology of the present invention is relatively complex, not all changes in the technology are foreseeable. The present subject matter described with reference to the example embodiments and set forth in the following claims is manifestly intended to be as broad as possible. For example, unless specifically otherwise noted, the claims reciting a single particular element also encompass a plurality of such particular elements. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. A support for a chafer having a frame, the support comprising:
an upper portion configured to be coupled to the frame;
a non-metallic body portion coupled to the upper portion and configured to provide structural support to the chafer; and
a lower portion coupled to the body portion;
wherein at least one of the upper portion and the lower portion comprise a metallic material.

2. The support of claim 1, wherein the body portion consists of non-metallic materials.

3. The support of claim 1, wherein both of the upper portion and the lower portion comprise metallic material.

4. The support of claim 1, wherein the upper portion and lower portion comprise a first material and the body portion comprises a second different material.

5. The support of claim 1, wherein the upper portion includes an projection configured to mate with a corresponding opening in the frame.

6. The support of claim 1, wherein the body portion comprises wood.

7. The chafer support of claim 1, wherein the body portion comprises plastic.

8. The support of claim 1, wherein at least a portion of the body portion is translucent or transparent.

9. The chafer support of claim 8, wherein the body portion includes a decorative article.

10. The support of claim 9, wherein the decorative article is at least partially received within the body portion.

11. The support of claim 1, further comprising a coupling member coupled to the upper portion and the lower portion and extending through a passage in the body portion.

12. The support of claim 11, wherein coupling member comprises a threaded rod.

13. A chafer system comprising:
a receptacle;
a frame supporting the receptacle; and
a plurality of supports coupled to the frame;
wherein at least one of the supports comprises a mounting portion coupled to the frame, a foot portion, and a body portion extending between the mounting portion and the foot portion.

14. The chafer system of claim 13, wherein the mounting portion includes a mounting surface configured to contact a portion of the frame.

15. The chafer system of claim 13, wherein the mounting portion is coupled to the frame by at least one fastener or is welded to the frame.

16. The chafer system of claim 13, wherein the mounting portion is threadably coupled to the body portion and/or the foot portion is threadably coupled to the body portion.

17. The chafer system of claim 13, wherein the non-metallic body portion comprises a translucent or transparent plastic.

18. A chafer support configured to support a chafer rack comprising:
a body portion configured to be coupled to a chafer rack, wherein at least a portion of the body portion is translucent or transparent.

19. The chafer support of claim 18, further comprising a decorative article.

20. The chafer support of claim 19, wherein the decorative article is at least partially received within the body portion.

21. The chafer support of claim 19, wherein the decorative article is embedded within the body portion.

22. The chafer support of claim 19, wherein the decorative article may be removed from the body portion and replaced with a second decorative article.

23. The chafer support of claim 19, wherein the decorative article is three-dimensional.

24. The chafer support of claim 18, further comprising:
an upper portion coupled to the body portion, the body portion having a first end proximate to the upper portion and a second end distal to the first end; and
a lower portion coupled to the body portion at a point proximate to the second end.

25. The chafer support of claim 24, wherein the upper portion is configured to be coupled to a chafer frame.

26. A chafer system comprising:
a frame configured to support a receptacle; and
a plurality of supports coupled to the frame and configured to extend substantially vertically from the frame to a support surface wherein at least one of the supports comprises a body portion that is generally symmetrical about a longitudinal axis of the at least one support.

27. The chafer system of claim 26, wherein at least one of the supports comprises:
an upper portion configured to be mounted to a frame;
a body portion coupled to the upper portion, the body portion having a first end proximate to the upper portion and a second end distal to the first end; and
a lower portion coupled to the body portion at a point proximate to the second end.

28. The chafer system of claim 27 wherein the upper portion is coupled to the frame by at least one fastener or is welded to the frame.

29. The chafer system of claim 27 further comprising a coupling member connected to the upper portion and to the lower portion.

30. The chafer system of claim 29 wherein the coupling member is a threaded rod that is threadably connected to the upper portion and to the lower portion.

31. The chafer system of claim 30 wherein the threaded rod is also threadably connected to the body portion.

32. The chafer system of claim 27 wherein the body portion is secured in place by the upper portion and to the lower portion.
